(19) United States
(12) Patent Application Publication
(10) Pub. No.: US 2005/0273452 A1
(43) Pub. Date: Dec. 8, 2005

(54) Matching database records

(75) Inventors: Rick A. Molloy, Redmond, WA (US); Keith Franklin Kelly, Bellevue, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/860,758

(22) Filed: Jun. 4, 2004

(51) Int. Cl. G06F 7/00

(52) U.S. Cl. 707/1

(57) ABSTRACT

Database records having n fields are analogized to points in n-dimensional space. “Distances” between records are calculated and used to assess the likelihood that those records pertain to the same instance of an item or event of interest. A distance between two records can be based on the distances between corresponding fields of those two records. For certain types of data, a distance between two fields may be a simple difference between the magnitudes of the two field values. For other types of data, the distance may be determined in other ways. Weights may be assigned to the field distances prior to determining record distances.

### FIELD OF THE INVENTION

The present invention relates to comparing records of one or more databases. In particular, the present invention pertains to determining the likelihood that two records are intended to describe the same thing.

### BACKGROUND OF THE INVENTION

It is frequently desirable to match records in one database with records in another database so as to identify records which are intended to describe the same item, event, transaction or other instance of a particular phenomenon. Balancing a checkbook provides a useful example. As a person (e.g., the account holder) writes checks, makes deposits, makes electronic funds transfers and performs other checking account actions, the account holder typically makes corresponding notes in a paper or electronic transaction register. At periodic intervals (e.g., monthly) the bank or other financial institution providing the account sends a statement (in either electronic or paper form) indicating account activity in the preceding month. The account holder must then reconcile the transactions identified in the statement with the transactions noted in the account holder's records. In other words, the account holder must find transactions in the transaction register that match transactions identified in the account statement.

In the area of personal financial record keeping, as well as in numerous other areas, it is desirable to automate the matching of database records. Although simple in theory, this is often complicated by lack of complete identity between the records that “match.” Continuing with the bank account example, the account holder may incorrectly note the date or amount of a transaction, may write the wrong check number, may fail to note a check number or amount, or may make numerous other mistakes. Even if the account holder is very careful when recording transactions, his or her record for a given transaction may still not coincide with the bank's record for that transaction. For example, the account holder may record the date he or she writes a check, but a bank statement may reflect the date that the bank processed the check. For these and other reasons, automatically matching database records continues to present challenges.

### SUMMARY OF THE INVENTION

According to at least some embodiments of the invention, database records having n fields are analogized to points in n-dimensional space. “Distances” between those records are then calculated and used to assess the likelihood that those records pertain to the same instance of an item or event of interest. In at least some embodiments, a distance between two records is based on the distances between corresponding fields of those two records. For certain types of data, a distance between two fields may be a simple difference between the magnitudes of the two field values. For other types of data, the distance may be determined in other ways. Because large differences in values for some fields may be consistent with matching records, and small differences in values for other fields may be indicative of non-matching records, weights may be assigned to the field distances. These and other features and advantages of the present invention will be readily apparent and fully understood from the following detailed description of various embodiments, taken in connection with the appended drawings.

### BRIEF DESCRIPTION OF THE DRAWINGS

FIG. 1 shows two database records mapped on a set of coordinate axes.

FIG. 2 shows two databases mapping records onto sets of coordinate axes.

FIG. 3 shows coordinate axes for one database superimposed on the axes for another database, together with the distance between two matching non-identical records.

FIG. 4 is a block diagram of a user database of account holder transaction records and a bank statement reflecting transaction records for the same account.

FIGS. 5 and 6 show a filtering algorithm for comparing payee name strings.

FIGS. 7 through 9 show an algorithm, according to at least some embodiments of the invention, for calculating a distance between two database records.

FIG. 10 illustrates comparison of multiple records in one database with multiple records in another database.

FIG. 11 is a list of database record pairs and calculated distances between records of each pair.

FIG. 12 shows the list of FIG. 11 after selection of a record pair as a match.

FIG. 13 shows the list of FIG. 12 after selection of another record pair as a match.

FIGS. 14 and 15 show an algorithm, according to at least one embodiment of the invention, for matching records in two databases.

FIG. 16 is a block diagram of a general-purpose digital computing environment that can be used to implement various aspects of the invention.

### DETAILED DESCRIPTION OF THE PREFERRED EMBODIMENTS

Embodiments of the invention permit records from multiple databases to be matched with one another when the matching records are not perfectly identical. The invention will be described using a financial account (e.g., a personal checking account) as an example. However, the invention is not limited by the type of information stored in databases for which records are to be matched. Aspects of the invention may be implemented with program modules or other instructions that can be executed on a computing device. Generally, program modules include routines, programs, objects, components, data structures, etc. that perform particular tasks or implement particular abstract data types. Because the invention may be implemented using software, an example of a general purpose computing environment is included at the end of the detailed description of the preferred embodiments. The invention is not limited to implementations involving a particular operating system or application program.

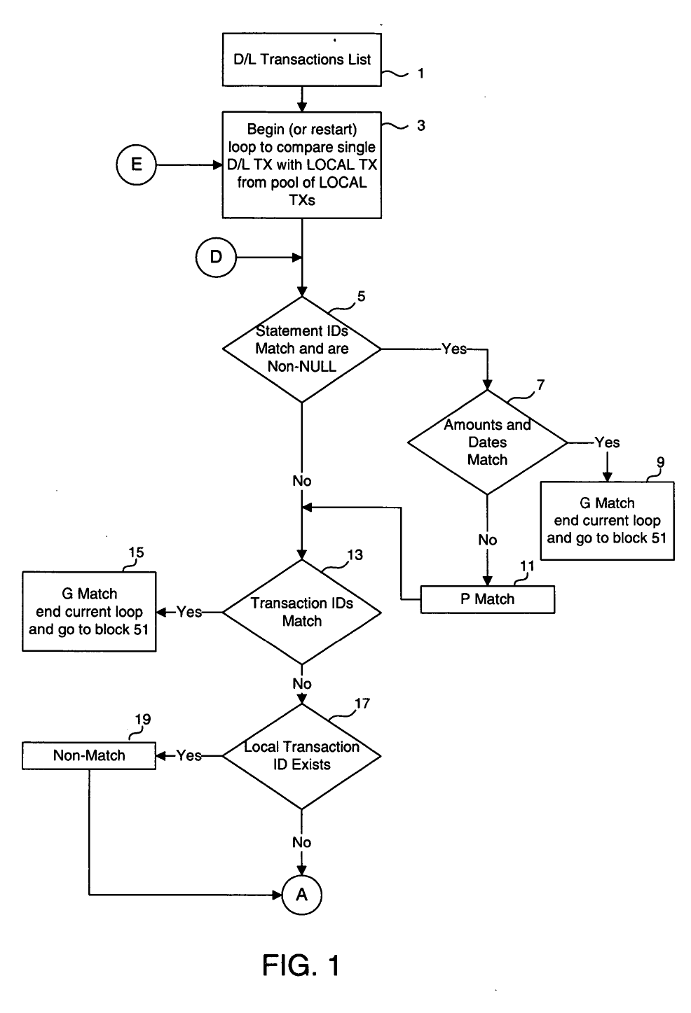

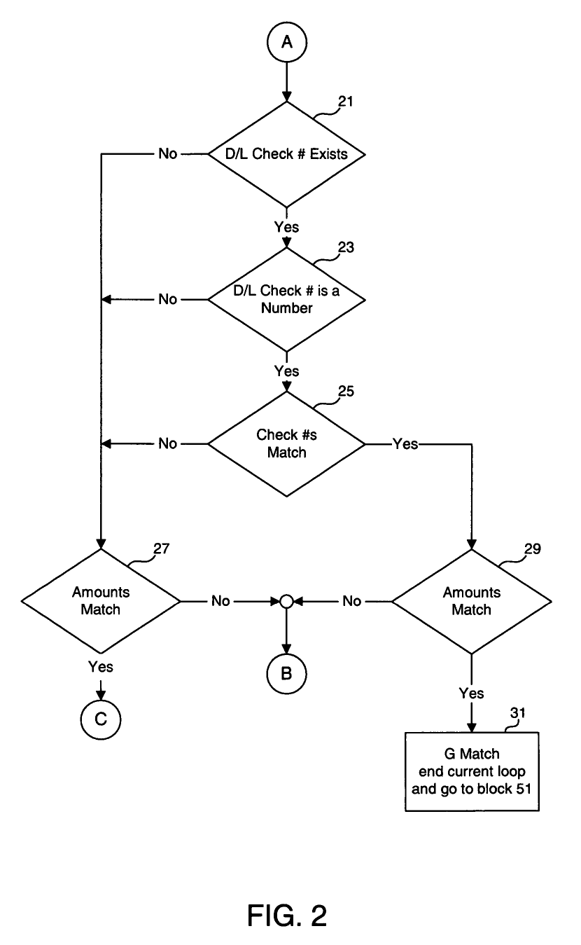

A database record, or tuple, having n fields can be analogized to a point in n-dimensional space. FIG. 1 shows a simple example of a financial database record 1 having three fields: dollar amount, date, and payee. If each of these fields is treated as a coordinate along a set of axes, record 1 can be located in the space defined by graph 2. Record 3 can also be located in the same space. FIG. 2 extends this analogy.

Graph 4 corresponds to a database maintained by the holder of the financial account (also referred to as a user), and graph 6 corresponds to the database maintained by the financial institution (e.g., a bank) providing the account. Each database contains records corresponding to individual account transactions; each record has fields for amount, date and payee. Using the amount, date and payee axes on graphs 4 and 6, the records of each database can be represented as points in two representations of the same account “space.” When it is time to reconcile the two databases (e.g., to balance the account holder's checkbook), the goal is to map points in the account holder's version of the account space with points in the bank's version of that same space. If the account holder and the bank enter identical information in fields for records describing a transaction, the user database record and the matching bank database record will correspond to the same point in the account space.

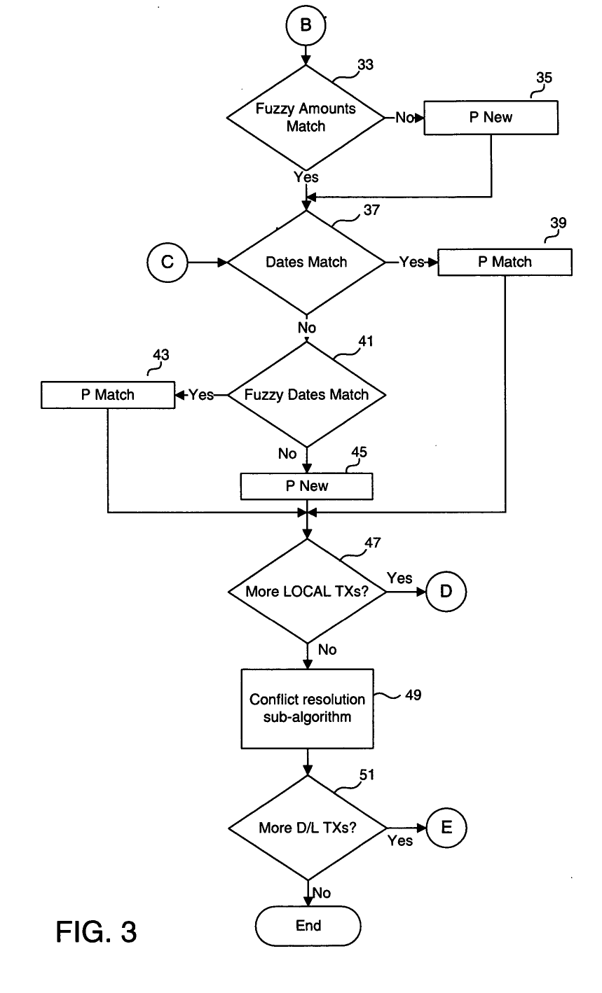

If the account holder and bank records for a given transaction are not perfectly identical, then as shown in FIG. 3, the points for these records will not coincide. In FIG. 3, graphs 4 and 6 are superimposed. Record 8 is the record of a particular transaction as reflected in the user database. Record 10 represents the record for that same transaction as reflected in the bank database. The user database record could diverge from the matching bank record for various reasons. For example, the account holder may have recorded the wrong amount for a check. If multiple other transactions (represented by points 12-16) in the user database are being reconciled with records on a bank statement (such as record 10), the goal is to determine which of the transactions represented by points 8 and 12-16 matches transaction 10. The distance between two points can be used as an indicator of whether the records corresponding to those points match. In many cases, a smaller distance between points for two records indicates a higher probability that the two records match. As illustrated in FIG. 3, the distance between records 8 and 10 is smaller than the distance between record 10 and any of records 12-16.

For three dimensions a, b and c, the distance between two points (a₁, b₁, c₁) and (a₂, b₂, c₂) is given by Equation 1.
distance=√ (a₁−a₂)²+(b₁−b₂)²+(c₁−c₂)², where Equation 1
a₁-a₂ is the distance between the points along the a axis,
b₁-b₂ is the distance between the points along the b axis, and
c₁-c₂ is the distance between the points along the c axis.
For the more general case of n dimensions Φ¹, Φ², Φ³, . . . Φⁿ, where n is an arbitrary number, the distance between two points (φ¹₁, Φ²₁, Φ³₁, . . . Φⁿ₁) and (Φ¹₂, Φ²₂, Φ³₂, . . . Φⁿ₂ is given by Equation 2.

$$\begin{matrix}Equation 2 \text{:} \\ distance = \sqrt{{( {Φ}_{1}^{1} - {Φ}_{2}^{1} )}^{2} + {( {Φ}_{1}^{2} - {Φ}_{2}^{2} )}^{2} + {( {Φ}_{1}^{3} - {Φ}_{2}^{3} )}^{2} + … + {( {Φ}_{1}^{n} - {Φ}_{2}^{n} )}^{2}}\end{matrix}$$

Unfortunately, the spatial analogy is not always a complete solution to the problem of matching database records. Unlike points in space, the relative importance of the information in each field of a database record should be considered when determining if two records match. In other words, relatively small differences in some fields may indicate a non-match, while relatively large differences in other fields may be consistent with a match. For example, many persons pay particular attention to the dollar amount when writing a check, as that is the amount of money with which the person is parting. Accordingly, discrepancies between corresponding account holder and bank record values for a given transaction amount tend to be small. Discrepancies for date field value may tend to be somewhat larger. Account holders often enter the date of writing a check as the date value for a particular transaction, but a bank statement typically reflects the date that the check is processed by the bank. Often, these dates are at least several days apart. Discrepancies for payee values may tend to be even larger. Many users enter an informal name for a payee (e.g., “gas”), but a bank statement record may reflect a corporate name (e.g., “ABC Petroleum Corp.”). Indeed, some users enter no payee at all. To account for these concerns, and as shown in Equation 3, the distance formula of Equation 2 is modified so as to assign a weight to the distances between like fields of two records being compared.

$$\begin{matrix}Equation 3 \text{:} \\ distance = \sqrt{\begin{matrix}{[ {w}_{1} ( {Φ}_{1}^{1} - {Φ}_{2}^{1} ) ]}^{2} + {[ {w}_{2} ( {Φ}_{1}^{2} - {Φ}_{2}^{2} ) ]}^{2} + \\ {[ {w}_{3} ( {Φ}_{1}^{3} - {Φ}_{2}^{3} ) ]}^{2} + … + {[ {w}_{n} ( {Φ}_{1}^{n} - {Φ}_{2}^{n} ) ]}^{2}\end{matrix}} ,\end{matrix}$$

where
(Φ¹₁−Φ¹₂₎ is a measure of the distance between two values for field Φ¹,
(Φ²₁−Φ²₂₎ is a measure of the distance between two values for field Φ²,
(Φ³₁−Φ³₂₎ is a measure of the distance between two values for field Φ³,
(Φⁿ₁−Φⁿ₂₎ is a measure of the distance between two values for field Φⁿ,
w₁ is a weight applied to the distance between the Φ¹ field values,
w₂ is a weight applied to the distance between the Φ² field values,
w₃ is a weight applied to the distance between the Φ³ field values, and
wₙ is a weight applied to the distance between the Φⁿ field values.
   In some cases, and as discussed below, the distance between two field values will not be a simple difference between two numerical values. The weight values w₁ through wₙ reflect the relative importance, when determining a match between records, of the data type within a particular record field.

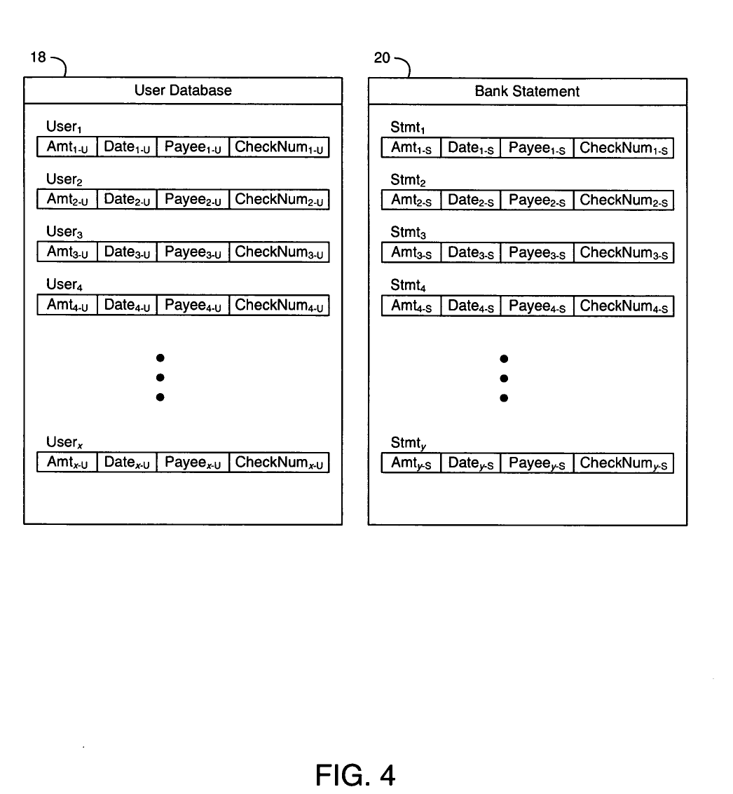

FIG. 4 shows a block diagram of a user database 18 of account holder transaction records. FIG. 4 also shows a block diagram of a bank statement 20. Statement 20 contains data for a portion of the records maintained by the bank for the account in question, and with which the account holder records are to be reconciled. Statement 20 is provided to the account holder in electronic form, e.g. as an e-mail attachment or via Internet download. In at least one embodiment, user database 18 is maintained by a personal financial software application. As a user writes checks, deposits money to a checking account, and performs other financial transactions, records are created in user database 18. In some cases, some or all of the data fields in a record may be populated automatically. For example, the financial software may have an on-line bill paying feature. When the user enters information via a dialog or other user interface (not shown) needed to pay a bill (e.g., payee, amount, etc.), that information is automatically stored in database 18. In other cases, the user may manually input data for some or all of the record fields. For example, the user may write a paper check at a store. When the user returns home, he or she launches the financial software application and types in the appropriate information (e.g., check number, amount, etc.).

For convenience, FIG. 4 shows records in user database 18 are labeled “User_,” where “_” is a number indicating one of records 1 through x in database 18. Similarly, records in bank statement 20 are labeled as “Stmt_,” where “_” is a number indicating one of records 1 through y in statement 20. The values “x” and “y” are arbitrary numbers, and x may or may not be the same as y. Each record in database 18 and statement 20 has four fields: transaction amount, transaction date, payee and check number. The fields for a record User_ of database 18 are labeled Amt_{—-U}, Date_{—-U}, Payee_{—-U} and CheckNum_{—-U}. Similarly, the fields for a record Stmt_ of statement 20 are labeled Amt_{—-S}, Date_{—-S}, Payee_{—-S} and CheckNum_{—-S}. So as not to unduly complicate the description to follow, records in user database 18 and statement 20 are limited to four fields. However, the invention is not limited by number of record fields or by type of information in the fields. Persons skilled in the art will appreciate, in light of the information provided herein, how additional (or fewer) fields and/or other field data types fields may be accommodated.

In order to calculate (using Equation 3) a distance between a record in statement 20 and a record in user database 18, distances between corresponding fields in those two records are first calculated. In at least some embodiments of the invention, the distance between the amount field values of two transaction records is simply the absolute value of the difference between those values. Thus, for example, the distance (Amt_Dist) between the amount field values for User₁ and Stmt₁ is |Amt_{1-U}-Amt_{1-S}|.

In at least some embodiments of the invention, the distance between the date field values of two records is determined in several steps. Often, only records in user database 18 for transactions within a certain time period will be considered for possible matching against records in a current bank statement. For example, a bank statement will often only contain records for transactions occurring within a recent period (e.g., the preceding month). Although there may be records in the user database for older transactions which have not yet been matched with records in earlier bank statements, such user records are not likely to match records in a statement for a recent period. Accordingly, the date field values of user records for transactions outside a predefined date window (e.g., more than 120 days before the current date) should generate a large date field distance when compared to a record in the current statement.

A record in user database 18 is determined to be inside or outside of the date window by first subtracting the date window from the current date (represented as a number of days from an arbitrarily chosen date, e.g., Jan. 1, 1900). The date field value in the user database record is also converted to a number of days from the same arbitrarily chosen date, and is then compared to the (current date-date window) difference. If the date field value is less than the (current date-date window) difference, the record corresponds to a transaction outside of the time window. In such case, a large number is assigned to the distance between the date fields of the user database record and the statement record being compared. If the date field value is not less than the (current date-date window) difference, the record corresponds to a transaction within the date window. In such case, the date field distance is calculated as the absolute value of the difference between the date field values of the records being compared. The following pseudocode illustrates this determination of date field distance (Date_Dist) for arbitrary records Userₖ and Stmtᵣ (where k may or may not be the same as r):
If Date_{k-U}<(Current_Date-Date_Window),
   then Date_Dist=DBL_MAX
   else Date_|Dist_{r-S}-Date_{k-U}|
      “DBL_MAX” is selected to be a large number. In at least some embodiments, DBL_MAX is the largest possible number which can be represented in a particular software application implementing the invention. For example, in embodiments implemented using the VISUAL C++ programming language (available from Microsoft Corporation of Redmond, Wash.), DBL_MAX is globally defined as 1.7976931348623158×10³⁰⁸. In still other embodiments, DBL_MAX is defined to be positive infinity.

In at least some embodiments, the distance (CheckNum_Dist) between check number field values for two records is either 0.0 (indicating a perfect match) or DBL_MAX (indicating a complete mismatch). In other words:
If CheckNum_{r-S}==CheckNum_{k-U},
   then CheckNum_Dist=0.0
   else CheckNum_Dist=DBL_MAX
      In certain embodiments, the CheckNum field value of the statement record (and/or of the user record) is filtered before the two check number field values are compared.

For example, leading zeros in a check number may be deleted. Thus, if a statement record indicates that a check number for a transaction is “00003015,” that value is first converted to “3015”. In other embodiments, the distance between check numbers is not a binary operation. In other words, the distance may have values other than zero and DBL_MAX. For example, the CheckNum distance computation can determine whether there are any transpositions in the CheckNum field of the user record. If a statement record indicates the check number is “3015”, but the user record indicates a check number as “3051”, an intermediate value (e.g., 10, 100, 1000, etc.) could be assigned to CheckNum_Dist.

In at least some embodiments, the distance Payee_Dist between values for the payee fields of two records is also either 0.0 or DBL_MAX. If character strings in the payee fields of two records being compared are the same, Payee_Dist is zero. Otherwise, Payee_Dist is DBL_MAX. In other words,
Payee_{r-S}==Payeek_U,
   then Payee_Dist=0.0
   else Payee_Dist=DBL_MAX
      However, the payee fields of a statement record and a user record may identify the same payee even if the contents of the two fields are not identical. For example, many users do not always record the complete name of a payee when writing a check. By way of illustration, a user may write a check at a grocery store, and indicate in the user database that the check was written to “ABC Food.” When the check is processed, however, the bank may record a more detailed name for the payee. If ABC Food is part of a large chain of supermarkets, a bank statement might indicate that the check payee was “ABC Food Co. Store#1234” or “ABC Food1234.” In some cases, the payee names in the user database records and in the statement records can be automatically filtered such that matching non-identical payee names can be identified.

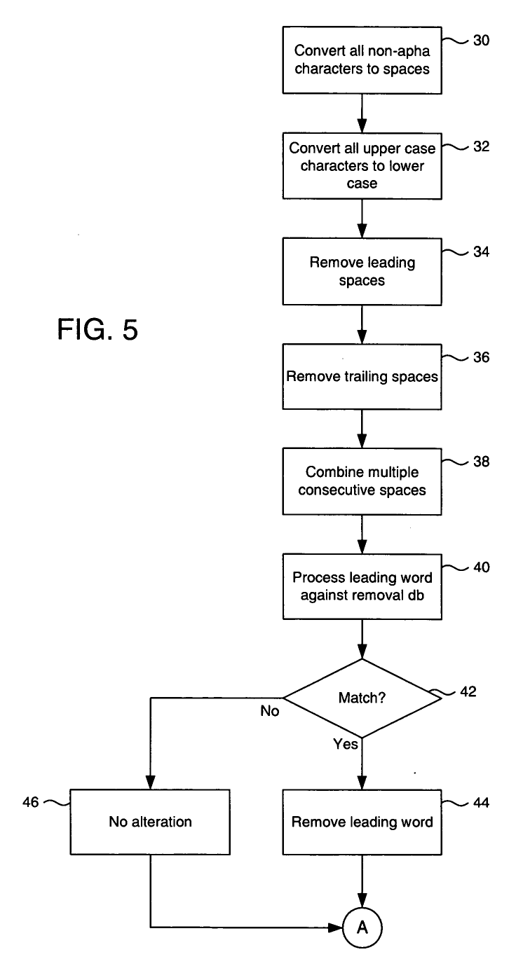

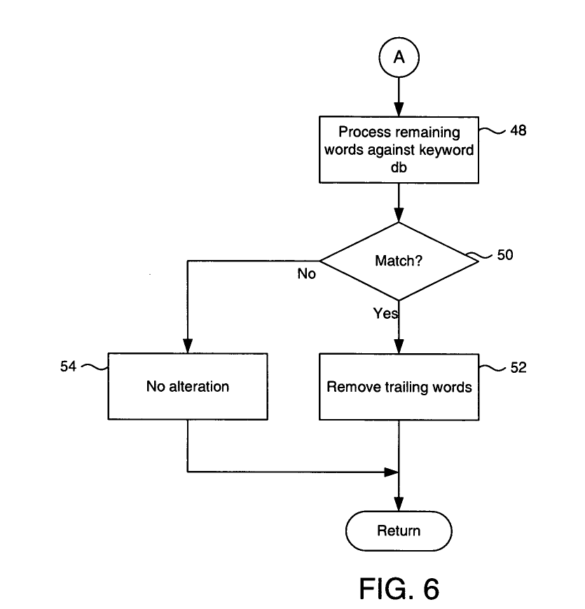

FIGS. 5 and 6 are a flow chart showing a payee filtering algorithm performed, in certain embodiments of the invention, when comparing payee fields of two records. This algorithm is performed on the payee field value in the statement record and on the payee field value in the user record. As explained in more detail below, this algorithm may be called as part of an algorithm calculating a distance between two records. In some embodiments, this filtering algorithm is performed in connection with other features of a financial software application, but the filtered payee names are stored and also used in connection with a record matching algorithm.

In block 30, all of the non-alphabet characters in a payee field value are converted to spaces. Thus, “ABC Food1234” would become “ABC Food ”. In block 32, all upper case characters in a payee field are translated to lower cases characters (e.g., “ABC Food ” becomes (abc food ”). In block 34, any leading spaces in a payee field are removed. In block 36, any trailing spaces in a payee field are removed (e.g., “abc food ” is now “abc food”). In block 38, any multiple consecutive spaces in a payee name are converted to one space. If, for example, the user had included extra spaces between ABC and Food, those multiple spaces would be converted to one space.

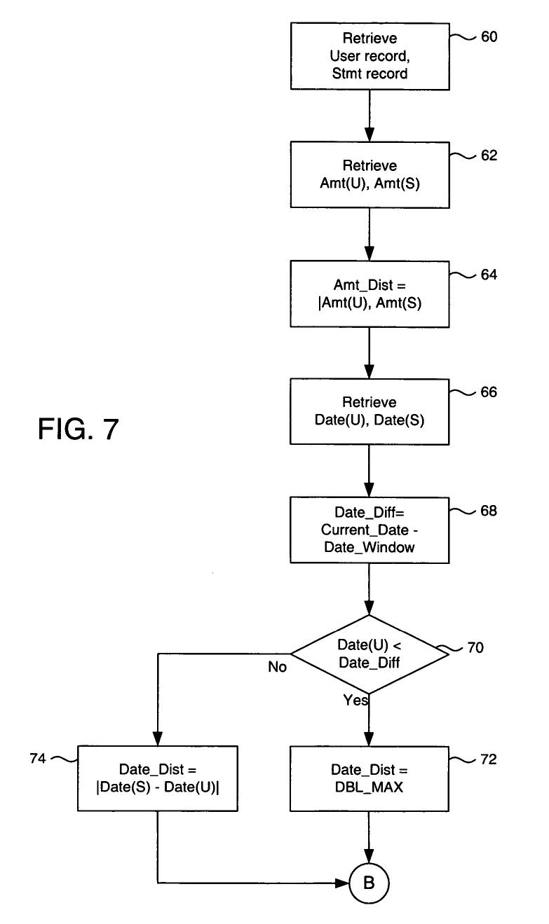

In block 40, the leading word of a payee name is then compared to a database of leading words which can be removed. In particular, there are certain words, phrases and characters that either appear so frequently that they are not useful for determining matches, or that are often included in a payee name by many banks and other financial institutions but rarely included by users. Examples include “check,” “ch,” “ATM,” and “fee.” If the first word of a payee field matches one of the words in the leading word database (block 42), the first word is removed in block 44. Otherwise, no alterations are made (block_46). From block 44, the algorithm continues (via off-page connector A) to block 48 (FIG. 6). At block 48, each word in a payee field (as modified by in blocks 30 through 44) is next compared to another database of various key words. These keywords include various commonly known stores, restaurants, financial institutions, and other entities with which many users do business. Examples include MASTERCARD, VISA, TEXACO, SAFEWAY, etc. Moreover, this keyword database may be modifiable by a user such that a user may add additional keywords if desired. Thus, a user may create his or her own “shorthand” for particular payees to whom the user frequently writes checks. If a match is detected at block 50, the remaining words in the payee name are removed at block 52. If there are no matches to any of the keywords, no further changes are made to the payee field (block 54). After block 52 or 54, the algorithm returns to the calling algorithm (described below in connection with FIGS. 7-9).

After the filtering of FIGS. 5 and 6 is performed on both of the payee field values of two records being compared, those fields are then evaluated for a match. If the field values (as filtered) are the same, payee field distance (Payee_Dist) is 0.0. Otherwise, payee field distance is DBL_MAX.

After distances between corresponding fields have been calculated for a user database record and a statement record, a distance between the records is calculated using Equation 3. In at least some embodiments, the coefficients used in Equation 3 are as set forth in Table 1.

TABLE 1

| Field | Coefficient (w) |
|---|---|
| Amount | 0.65 |
| Date | 0.35 |
| Check No. | 0.35 |
| Payee | 0.15 |

Thus the distance between two records is [(0.65*Amount_Dist)²+(0.35* Date_Dist)²+(0.35*CheckNum_Dist)²+(0.15*Payee_Dist)²]^{1/2}.

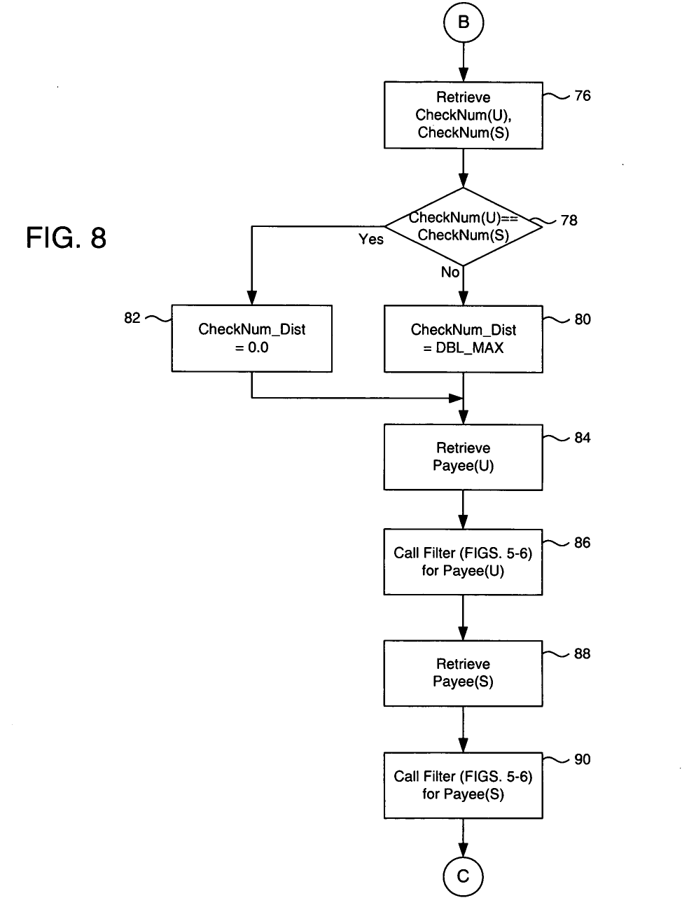

FIGS. 7-9 are a flow chart showing the above-described algorithm, according to some embodiments of the invention, for calculating a distance between a user database record and a statement record. In block 60 (FIG. 7), the user database record and the statement record to be compared are retrieved (or otherwise identified). In block 62, the amount fields Amt(U) and Amt(S) of the two records are retrieved. In block 64, the distance (Amt_Dist) between the two amount fields is calculated. In block 66, the date fields Date(U) and Date(S) of the two records are retrieved. In block 68, a quantity Date_Diff is calculated by taking the difference of the current date and a date window. In block 70, it is determined whether Date(U) is less than Date_Diff. If no, the distance (Date_Dist) between the two date fields is calculated in block 74 as the absolute value of the difference between Date(S) and Date(U). If yes, Date_Dist is set to DBL_MAX at block 72. From either block 72 or 74, the algorithm continues, via off-page connector B, to block 76 (FIG. 8).

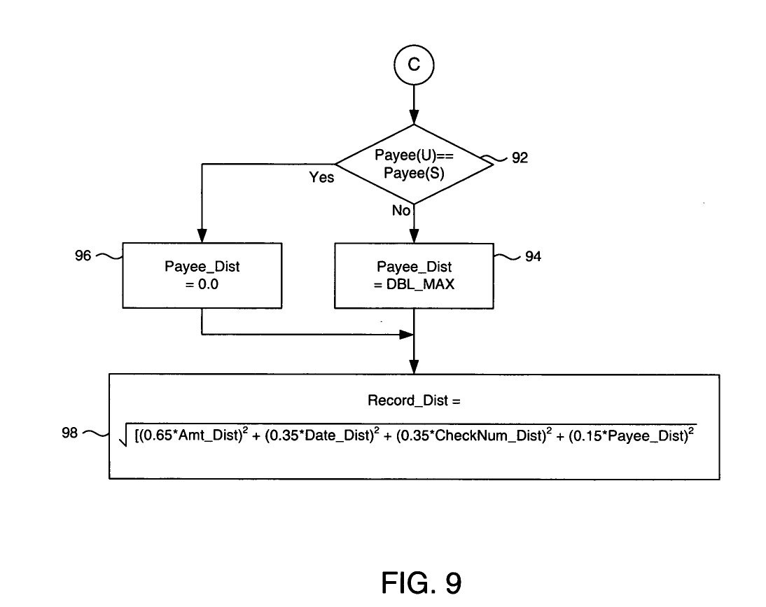

In block 76, the check number fields CheckNum(U) and CheckNum (S) of the two records are retrieved. At block 78, it is determined whether CheckNum(U) is the same as CheckNum(S). If no, the distance (CheckNum_Dist) between the two fields is set to DBL_MAX at block 80. If yes, CheckNum_Dist is set to 0.0 at block 82. At block 84, the payee field Payee(U) of the user database record is retrieved. In block 86, the filtering algorithm of FIGS. 5 and 6 is called and performed on Payee(U). At block 88, the payee field Payee(S) of the statement record is retrieved. In block 90, the filtering algorithm of FIGS. 5 and 6 is called and performed on Payee(S). From block 90, the algorithm continues, via off-page connector C, to block 92 (FIG. 9).

At block 92, it is determined whether Payee(U) (as filtered by the filtering algorithm of FIGS. 5 and 6) is the same as Payee(S) (as also filtered by the filtering algorithm). If no, the distance Payee_Dist between payee fields is set to DBL_MAX at block 94. If yes, Payee_Dist is set to 0.0 in block 96. In block 98, the distance Record_Dist between the two records is calculated.

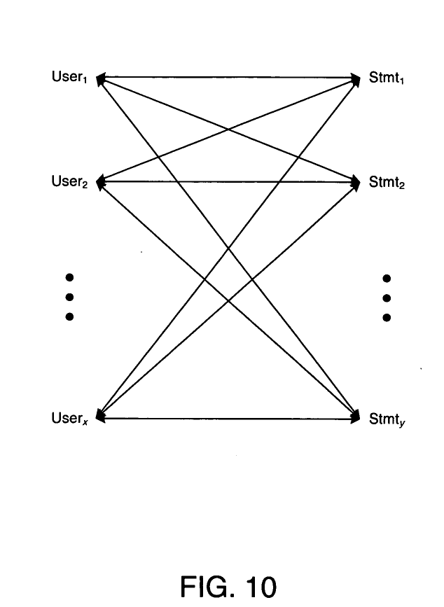

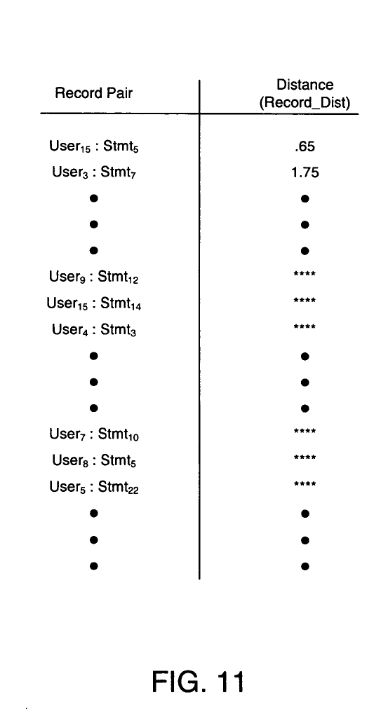

According to at least some embodiments of the invention, the algorithm of FIGS. 7-9 is used to calculate a distance (Record_Dist) between every previously unreconciled record in the user database and every record in the statement. Referring to FIG. 10, a distance is calculated between User₁ and each of Stmt₁ through Stmt_{y}. Distances are then calculated between User₂ and each of Stmt₁ through Stmt_{y}. A similar pattern is followed through Userₓ and each of Stmt₁ through Stmt_{y}. For each User/Stmt record pair comparison yielding a distance below a defined threshold (e.g., 0.75* DBL_MAX), an identifier for the record pair is stored with the distance between the pair. FIG. 11 shows an example of such a listing in tabular form, sorted by increasing distance. Example distances are included for the first two entries in FIG. 11, with distance values for other record pairs being generically indicated by “****”.

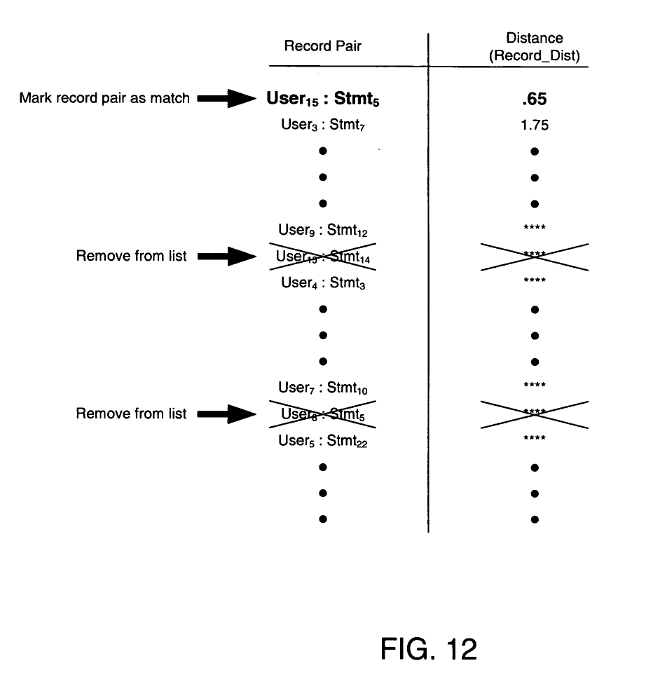

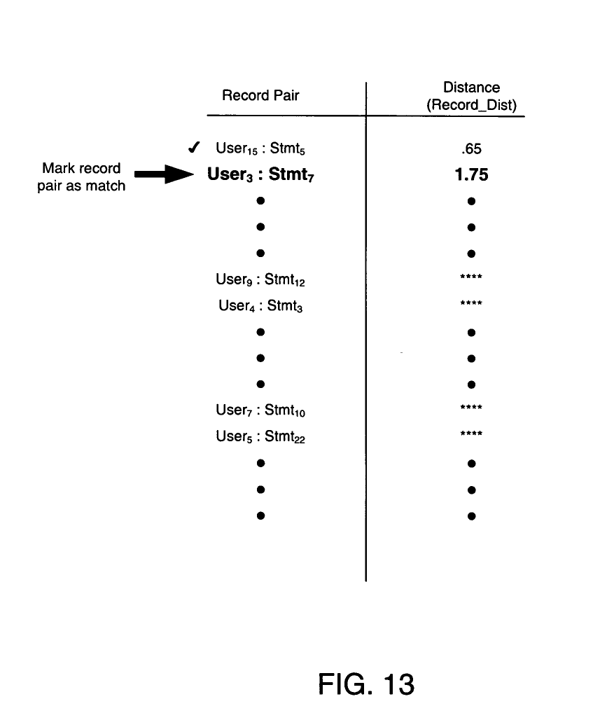

Using a ranked listing such as in FIG. 11, User/Stmt record pairs are then classified as matches. Starting at the top of the list, the entry for the record pair with the lowest distance (i.e., the highest match probability) is selected. In the example of FIG. 11, this is the User₁₅: Stmt₅ pair entry. The records in that pair are classified as matches, and remaining entries in the list referencing one of the matched records are removed from the list. The next record pair at the top of the list is selected, and the process repeats. This is further illustrated in FIGS. 12 and 13. As shown in FIG. 12, the record pair at the top of the list (i.e., having the lowest distance) is marked as a match. Next, each entry in the list referencing either User₁₅ (e.g., the entry for the User₁₅: Stmt₁₄ pair) or Stmt₅ (e.g., the entry for the User₈: Stmt₅ pair) is deleted from the list. As shown in FIG. 13, the User₁₅: Stmt₅ pair is marked as a match, the User₁₅: Stmt₁₄ and User₈: Stmt₅ entries have been deleted, and the User₃: Stmt₇ pair is selected as a match. Other entries referencing User₃ or Stmt₇ are also deleted (not shown).

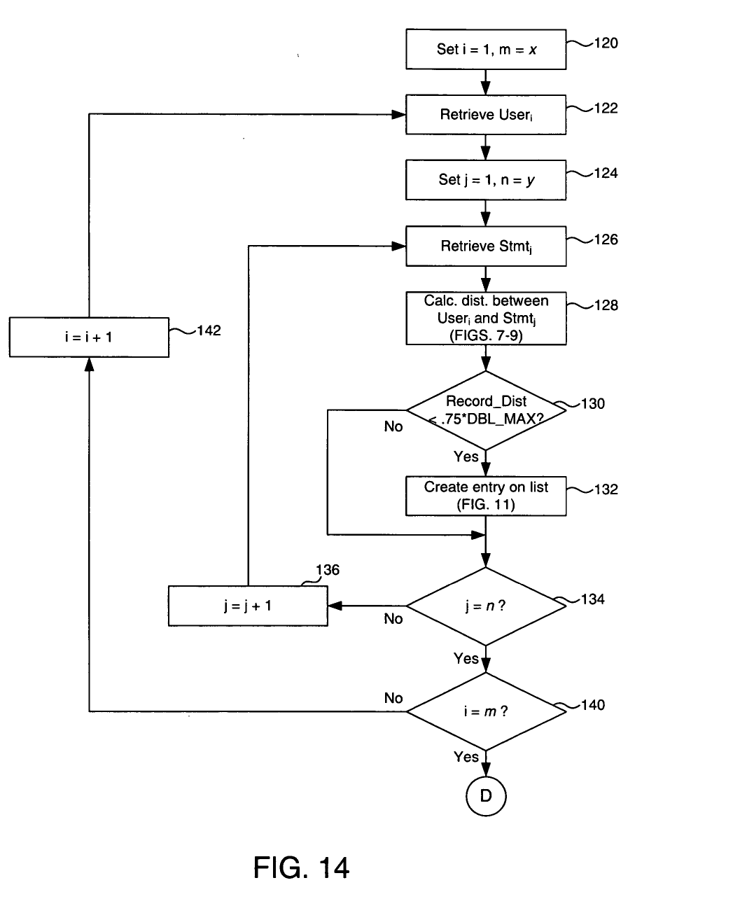

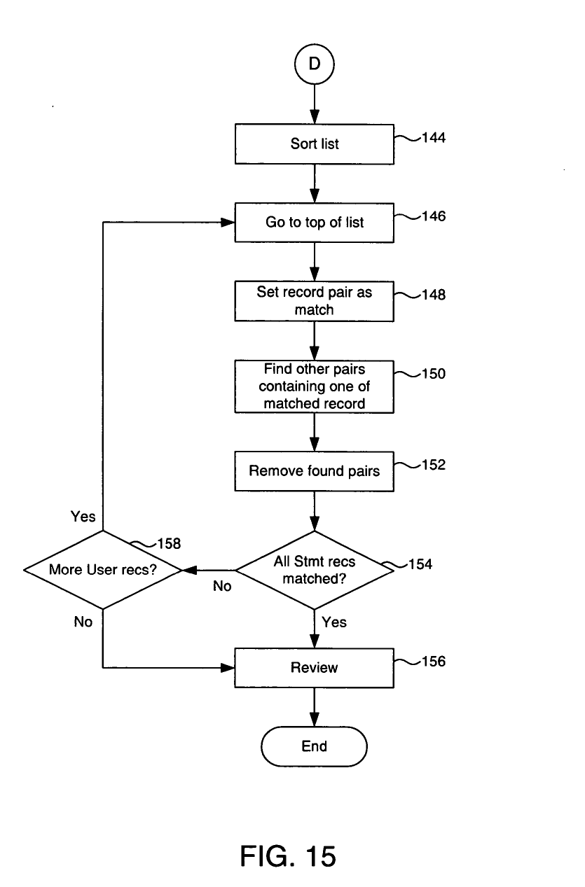

FIGS. 14 and 15 are a flow chart for an algorithm, according to at least one embodiment of the invention, for matching records in a user database to records in a bank statement. Beginning in block 120 (FIG. 14), loop counter i is set to 1, and a loop variable m is set to x, where x is the number of unreconciled records in the user database. At block 122, record Userᵢ is retrieved. At block 124, a second loop counter j is set to 1, and a second loop variable n is set to y, where y is the number of records in the statement. At block 126, record Stmtⱼ is retrieved. At block 128, the distance between Userᵢ and Stmtⱼ is calculated by calling the algorithm of FIGS. 7-9. At block 130, the resulting distance between Userᵢ and Stmtⱼ is compared to a threshold percentage of DBL_MAX (in at least one embodiment, the threshold is 0.75*DBL_MAX). If the Userᵢ: Stmtⱼ distance is below the threshold, an entry is created on a list of record pairs, such as in FIG. 11. If the Userᵢ: Stmtⱼ distance is not below the threshold, the algorithm bypasses block 132 (thereby not creating an entry on the list for the Userᵢ: Stmtⱼ distance) and proceeds directly to block 134. At block 134, it is determined whether loop counter j is equal to loop variable n. If no, j is incremented at block 136 and the algorithm returns to block 126. If yes, the algorithm proceeds to block 140. At block 140, it is determined whether loop counter i is equal to loop variable m. If no, i is incremented at block 142 and the algorithm returns to block 122. If yes, the algorithm proceeds, via off-page connector D, to block 144 (FIG. 15).

At block 144, all of the record pair distances on the list created in block 132 are sorted in ascending order of record distance. At block 146, the algorithm proceeds to the top of the list, and the record pair at the top of the list is marked as a match in block 148. In block 150, other record pairs in the list having one of the records of the just-marked pair as a component are identified. At block 152, the record pairs identified in block 150 are removed from the list. At block 154, it is determined whether all records in the statement have been matched. If all statement records have been matched, there are no further records to which user records can be reconciled; any remaining user database records could be errors (e.g., duplicate entries by the user), could correspond to transactions which the bank has not yet processed, or otherwise be records which will require specialized attention. If all statement records have been matched, the algorithm proceeds to block 156 (described below). If all statement records have not been matched, the algorithm proceeds (on the “no” branch) to block 158. At block 158, it is determined whether there are more unmatched user database records. If yes, the algorithm returns to block 146. If there are no more unmatched user database records, the algorithm proceeds to block 156. There may be no more unmatched user database records if, for example, the user forgot to enter one or more transactions in the user database, and specialized user attention may be required.

At block 156, the user is provided an opportunity to resolve discrepancies. For example, if there were more statement records than user database records, the user may indicate that the statement records should be made into new user database records. If there were more user database records than statement records, the user can look for duplicate entries. In at least some embodiments, the user is also provided an opportunity to review all of the record matches that were made automatically (i.e., by loops through blocks 144-150). In at least some embodiments, any record pairs that were automatically matched, but which have a record distance above a predetermined value, are called to the user's attention.

Numerous variations on the previously described algorithms are within the scope of the invention. Variations include, but are not limited to, the following:
Instead of (or in addition to) a check number, a field holding a value for some other type of index number could be used.
Although all the weights w in the previous examples were less than 1.0, weights of 1.0 or greater than 1.0 could be applied to various field distances in other embodiments.
All fields of a record need not be considered when determining distances between transactions. For example, user and bank database records for each transaction may include fields for transaction amount, transaction date, check number, payee, expense category, and another categorization (e.g., taxable or non-taxable). When determining whether two records are a match, the expense category and the other categorization may not be considered (e.g., treat the 6-dimensional record as a 4-dimensional record). As yet another variation, some of the record fields may not be used for initially determining distance between records, but may be used for deciding “ties” between record pairs having the same (or very similar) distances.
Other types of field distance calculations can be used.
Instead of a field distance being assigned one of two discrete values (as with the payee and check number fields in the above-described embodiments), additional values can be assigned based on other conditions. For example, if a user record payee field is null or blank (indicating, e.g., the user forgot to record the payee name) the payee field distance can be assigned an intermediate value between 0.0 and DBL_MAX (e.g., 0.5). Similarly, if a user record check number field is null or blank, the check number field distance can be assigned an intermediate value between 0.0 and DBL_MAX (e.g., 0.5).
As previously indicated, the invention is not limited to databases having records describing financial transactions. Instead of an amount of money (e.g., the amount fields in the above-described embodiments) or amount of time (e.g., the date fields in the above-described embodiments), fields of records being compared could hold numerical values corresponding to numerous other types of measurable quantities. For example, instead of an “amount” field containing a value for an amount of money in a transaction, the field could hold a numerical value for a measured quantity of some other tangible or non-tangible item (e.g., bushels of corn, boxes of widgets, kilowatt-hours of electricity, etc.). Similarly, instead of a payee name, fields of records being compared could hold other types of non-numerical values (e.g., book titles, Internet addresses, etc.).

General Purpose Computing Environment

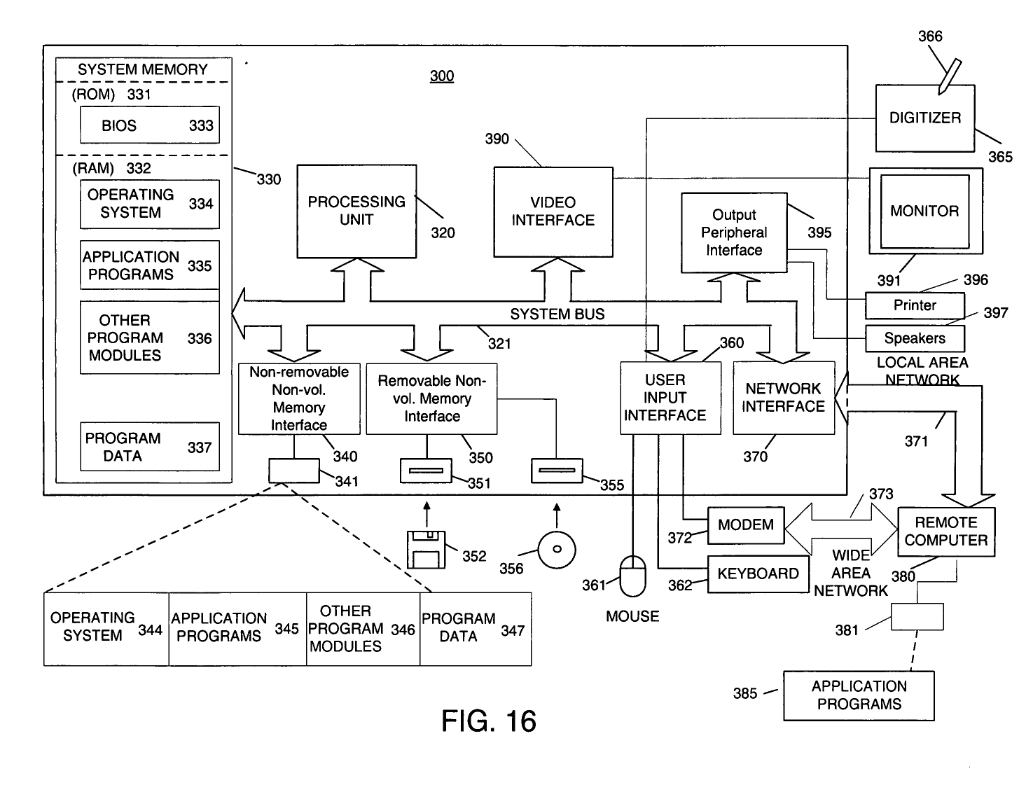

FIG. 16 illustrates an example of a suitable computing system environment on which the invention may be implemented. The computing system environment is only one example of a suitable computing environment and is not intended to suggest any limitation as to the scope of use or functionality of the invention. Neither should the computing environment be interpreted as having any dependency or requirement relating to any one or combination of components illustrated in the illustrative operating environment.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, tablet PCs, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 16, an illustrative system for implementing the invention includes a general purpose computing device in the form of a computer 300. Components of computer 300 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 300 typically includes a variety of computer readable media. Computer readable media can be any available media that can be accessed by computer 300 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 300. Communication media typically embodies computer readable instructions, data structures, program modules or other data in a modulated data signal such as a/carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 300, such as during start-up, is typically stored in ROM 331. RAM 332 typically contains data and/or program modules that are immediately accessible to and/or presently being operated on by processing unit 320. By way of example, and not limitation, FIG. 16 illustrates operating system 334, application programs 335, other program modules 336, and program data 337.

The computer 300 may also include other removable/non-removable, volatile/nonvolatile computer storage media. By way of example only, FIG. 16 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the illustrative operating environment include, but are not limited to, magnetic tape cassettes, flash memory cards, digital versatile disks, digital video tape, solid state RAM, solid state ROM, and the like. The hard disk drive 341 is typically connected to the system bus 321 through an non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 16 provide storage of computer readable instructions, data structures, program modules and other data for the computer 300. In FIG. 16, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 300 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through a output peripheral interface 395.

In some aspects, a pen digitizer 365 and accompanying pen or stylus 366 are provided in order to digitally capture freehand input. Although a direct connection between the pen digitizer 365 and the user input interface 360 is shown, in practice, the pen digitizer 365 may be coupled to the processing unit 320 directly, parallel port or other interface and the system bus 321 by any technique, including wirelessly. Also, the pen 366 may have a camera associated with it and a transceiver for wirelessly transmitting image information captured by the camera to an interface interacting with bus 321. Further, the pen may have other sensing systems in addition to or in place of a camera for determining strokes of electronic ink including accelerometers, magnetometers, and gyroscopes.

The computer 300 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 300, although only a memory storage device 381 has been illustrated in FIG. 16. The logical connections depicted in FIG. 16 include a local area network (LAN) 371 and a wide area network (WAN) 373, but may also include other networks. Such networking environments are commonplace in offices, enterprise-wide computer networks, intranets and the Internet. Further, the system may include wired and/or wireless capabilities. For example, network interface 370 may permit communication between computer 300 and other devices using BLUETOOTH, SWLan, and/or IEEE 802.11 protocols. It is appreciated that other wireless communication protocols may be used in conjunction with these protocols or in place of these protocols.

When used in a LAN networking environment, the computer 300 is connected to the LAN 371 through a network interface or adapter 370. When used in a WAN networking environment, the computer 300 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 300, or portions thereof, may be stored in the remote memory storage device. By way of example, and not limitation, FIG. 16 illustrates remote application programs 385 as residing on memory device 381. It will be appreciated that the network connections shown are illustrative and other means of establishing a communications link between computers may be used. For example, a cable modem (not shown) may connect to network interface 370 so as to connect computer 300 to the Internet. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

### CONCLUSION

Although specific examples of carrying out the invention have been described, those skilled in the art will appreciate that there are numerous variations and permutations of the above described systems and techniques that fall within the spirit and scope of the invention as set forth in the appended claims. Accordingly, the invention is not to be limited by the preceding examples, and is instead described by the claims appended hereto.

1. A method for matching record pairs in one or more databases, comprising:
(a) calculating, for each field of a plurality of fields of a first record, a field distance based on a corresponding field of a second record;
(b) weighting the field distances calculated in step (a);
(c) determining, using the weighted field distances from step (b), a record distance corresponding to the first and second records;
(d) calculating, for each field of the plurality of first record fields, a field distance based on a corresponding field of a third record;
(e) weighting the field distances calculated in step (d);
(f) determining, using the weighted field distances from step (e), a record distance corresponding to the first and third records; and
(g) selecting either the second or third record as a match to the first record based on the record distances determined in steps (c) and (f).

2. The method of claim 1, wherein:
at least one field of the plurality of first record fields contains a value representing a numerical magnitude of a measured quantity, and
at least one field of the plurality of first record fields contains a character string not representing a numerical magnitude of a measured quantity.

3. The method of claim 2, wherein the measured quantity is one of a date of an event, an amount or an index number for an event.

4. The method of claim 1, wherein:
for a first field of the plurality of first record fields and corresponding fields of the second and third records, calculating a field distance between two fields comprises computing a numerical difference between values of the two fields, and
for a second field of the plurality of first record fields and corresponding fields of the second and third records, calculating a field distance between two fields comprises setting the field distance to one of a plurality of discrete values.

5. The method of claim 4, wherein:
for the second field of the plurality of first record fields and corresponding fields of the second and third records, calculating a field distance between two fields comprises filtering a value of at least one of the two fields,
the field distance is set to a first discrete value of the plurality of discrete values if the values of the two fields are the same after filtering the value of at least one of the two fields, and
the field distance is set to a second discrete value of the plurality of discrete values if the values of the two fields are not the same after filtering the value of at least one of the two fields.

6. The method of claim 1, wherein determining a record distance in steps (c) and (f) comprises, respectively, calculating the square root of the sum of the squares of the weighted field distances from step (b) and calculating the square root of the sum of the squares of the weighted field distances from step (e).

7. The method of claim 1, wherein the first, second and third records comprise records describing financial transactions.

8. The method of claim 7, wherein a first field of the plurality of first record fields represents transaction amount, a second field of the plurality of first record fields represents transaction date, and a third field of the plurality of first record fields represents at least one of transaction index number and payee description.

9. The method of claim 1, wherein:
a first field of the plurality of first record fields and corresponding fields of the second and third records represent transaction amount,
calculating a field distance between two transaction amount fields comprises computing the absolute value of a difference between values of the two transaction amount fields,
a second field of the plurality of first record fields and corresponding fields of the second and third records represent transaction date,
calculating a field distance between two transaction date fields comprises computing the absolute value of a difference between values of the two transaction date fields,
a third field of the plurality of first record fields and corresponding fields of the second and third records represent transaction index number,
calculating a field distance between two transaction index number fields comprises setting the field distance to one of a first plurality of discrete values,
a fourth field of the plurality of first record fields and corresponding fields of the second and third records represent payee description, and
calculating a field distance between two payee description fields comprises setting the field distance to one of a second plurality of discrete values.

10. The method of claim 9, wherein:
calculating a field distance between two transaction date fields comprises setting the field distance to a predefined value if a value of at least one of the two transaction date fields is outside a predetermined range.

11. The method of claim 9, wherein:
calculating a field distance between two transaction index number fields comprises filtering a value of at least one of the two transaction index number fields,
the field distance for the third field is set to a first discrete value if values of the two transaction index number fields are the same after filtering the value of at least one of the two transaction index number fields, and
the field distance for the third field is set to a second discrete value if values of the two transaction index number fields are not the same after filtering the value of at least one of the two transaction index number fields.

12. The method of claim 9, wherein
calculating a field distance between two payee description fields comprises filtering a value of at least one of the two payee description fields,
the field distance for the fourth field is set to a first discrete value if values of the two payee description fields are the same after filtering the value of at least one of the two payee description fields, and
the field distance for the fourth field is set to a second discrete value if values of the two payee description fields are not the same after filtering the value of at least one of the two payee description fields.

13. The method of claim 9, wherein:
the first and second plurality of discrete values are the same,
calculating a field distance between two transaction index number fields comprises setting the field distance to a first discrete value if values of the two transaction index number fields match and to a second discrete value if the values of the two transaction index number fields do not match, and
calculating a field distance between two payee description fields comprises setting the field distance to the first discrete value if values of the two payee description fields match and to the second discrete value if values of the two payee description fields do not match.

14. The method of claim 1, wherein the first record is part of a first group of records and the second and third records are part of a second group of records, and further comprising:
(h) calculating, for each field of the plurality first record fields, a field distance based on a corresponding field of a subsequent record of the second group;
(i) weighting the field distances calculated in step (h);
(j) determining, using the weighted field distances from step (i), a record distance corresponding to the first record and the subsequent record;
(k) repeating steps (h) through (j) with regard to the first record and additional records of the second group;
(l) repeating steps (a) through (f) and (h) through (k) with regard to additional records of the first group, and wherein step (g) comprises:
sorting values for record distances, and
selecting matching records based on minimum record distances.

15. The method of claim 14, further comprising:
(m) comparing each record distance to a threshold value; and
(n) excluding from further consideration record distances above the threshold value.

16. A computer-readable medium having stored thereon data representing sequences of instructions which, when executed by a processor, cause the processor to perform steps of method for matching record pairs in one or more databases, the steps comprising:
(a) calculating, for each field of a plurality of fields of a first record, a field distance based on a corresponding field of a second record;
(b) weighting the field distances calculated in step (a);
(c) determining, using the weighted field distances from step (b), a record distance corresponding to the first and second records;
(d) calculating, for each field of the plurality of first record fields, a field distance based on a corresponding field of a third record;
(e) weighting the field distances calculated in step (d);
(f) determining, using the weighted field distances from step (e), a record distance corresponding to the first and third records; and
(g) selecting either the second or third record as a match to the first record based on the record distances determined in steps (c) and (f).

17. The computer-readable medium of claim 16, wherein:
at least one field of the plurality of first record fields contains a value representing a numerical magnitude of a measured quantity, and
at least one field of the plurality of first record fields contains a character string not representing a numerical magnitude of a measured quantity.

18. The computer-readable medium of claim 17, wherein the measured quantity is one of a date of an event, an amount or an index number for an event.

19. The computer-readable medium of claim 16, wherein:
for a first field of the plurality of first record fields and corresponding fields of the second and third records, calculating a field distance between two fields comprises computing a numerical difference between values of the two fields, and
for a second field of the plurality of first record fields and corresponding fields of the second and third records, calculating a field distance between two fields comprises setting the field distance to one of a plurality of discrete values.

20. The computer-readable medium of claim 19, wherein:
for the second field of the plurality of first record fields and corresponding fields of the second and third records, calculating a field distance between two fields comprises filtering a value of at least one of the two fields,
the field distance is set to a first discrete value of the plurality of discrete values if the values of the two fields are the same after filtering the value of at least one of the two fields, and
the field distance is set to a second discrete value of the plurality of discrete values if the values of the two fields are not the same after filtering the value of at least one of the two fields.

21. The computer-readable medium of claim 16, wherein determining a record distance in steps (c) and (f) comprises, respectively, calculating the square root of the sum of the squares of the weighted field distances from step (b) and calculating the square root of the sum of the squares of the weighted field distances from step (e).

22. The computer-readable medium of claim 16, wherein the first, second and third records comprise records describing financial transactions.

23. The computer-readable medium of claim 22, wherein a first field of the plurality of first record fields represents transaction amount, a second field of the plurality of first record fields represents transaction date, and a third field of the plurality of first record fields represents at least one of transaction index number and payee description.

24. The computer-readable medium of claim 16, wherein:
a first field of the plurality of first record fields and corresponding fields of the second and third records represent transaction amount,
calculating a field distance between two transaction amount fields comprises computing the absolute value of a difference between values of the two transaction amount fields,
a second field of the plurality of first record fields and corresponding fields of the second and third records represent transaction date,
calculating a field distance between two transaction date fields comprises computing the absolute value of a difference between values of the two transaction date fields,
a third field of the plurality of first record fields and corresponding fields of the second and third records represent transaction index number,
calculating a field distance between two transaction index number fields comprises setting the field distance to one of a first plurality of discrete values,
a fourth field of the plurality of first record fields and corresponding fields of the second and third records represent payee description, and
calculating a field distance between two payee description fields comprises setting the field distance to one of a second plurality of discrete values.

25. The computer-readable medium of claim 24, wherein:
calculating a field distance between two transaction date fields comprises setting the field distance to a predefined value if a value of at least one of the two transaction date fields is outside a predetermined range.

26. The computer-readable medium of claim 24 wherein:
calculating a field distance between two transaction index number fields comprises filtering a value of at least one of the two transaction index number fields,
the field distance for the third field is set to a first discrete value if values of the two transaction index number fields are the same after filtering the value of at least one of the two transaction index number fields, and
the field distance for the third field is set to a second discrete value if values of the two transaction index number fields are not the same after filtering the value of at least one of the two transaction index number fields.

27. The computer-readable medium of claim 24, wherein
calculating a field distance between two payee description fields comprises filtering a value of at least one of the two payee description fields,
the field distance for the fourth field is set to a first discrete value if values of the two payee description fields are the same after filtering the value of at least one of the two payee description fields, and
the field distance for the fourth field is set to a second discrete value if values of the two payee description fields are not the same after filtering the value of at least one of the two payee description fields.

28. The computer-readable medium of claim 24, wherein:
the first and second plurality of discrete values are the same,
calculating a field distance between two transaction index number fields comprises setting the field distance to a first discrete value if values of the two transaction index number fields match and to a second discrete value if the values of the two transaction index number fields do not match, and
calculating a field distance between two payee description fields comprises setting the field distance to the first discrete value if values of the two payee description fields match and to the second discrete value if values of the two payee description fields do not match.

29. The computer-readable medium of claim 16, wherein the first record is part of a first group of records and the second and third records are part of a second group of records, and comprising further instructions for performing steps comprising:
(h) calculating, for each field of the plurality first record fields, a field distance based on a corresponding field of a subsequent record of the second group;
(i) weighting the field distances calculated in step (h);
(j) determining, using the weighted field distances from step (i), a record distance corresponding to the first record and the subsequent record;
(k) repeating steps (h) through (j) with regard to the first record and additional records of the second group;
(l) repeating steps (a) through (f) and (h) through (k) with regard to additional records of the first group, and wherein step (g) comprises:
sorting values for record distances, and
selecting matching records based on minimum record distances.

30. The computer-readable medium of claim 29, comprising further instructions for performing steps comprising:
(m) comparing each record distance to a threshold value; and
(n) excluding from further consideration record distances above the threshold value.
